(19) United States
(12) Patent Application Publication
(10) Pub. No.: US 2026/0034873 A1
(43) Pub. Date: Feb. 5, 2026

(54) COOLANT CIRCULATION SYSTEM

(71) Applicant: Mazda Motor Corporation, Aki-gun (JP)

(72) Inventors: Yuma Miyauchi, Aki-gun (JP); Shoko Horibata, Aki-gun (JP); Kentaro Kawaguchi, Aki-gun (JP)

(21) Appl. No.: 19/267,950

(22) Filed: Jul. 14, 2025

(30) Foreign Application Priority Data
Jul. 31, 2024 (JP) 2024-124227

(51) Int. Cl. B60K 1/00; B60H 1/00; B60H 1/32; B60L 58/26; F16C 33/10; H01M 10/613; H01M 10/625; H01M 10/6569; H01M 10/663; H02K 9/19

(52) U.S. Cl. CPC B60K 1/00; B60H 1/00278; B60H 1/3229; B60L 58/26; F16C 33/1045; H01M 10/613; H01M 10/625; H01M 10/6569; H01M 10/663; H02K 9/19; B60H 2001/00307; B60K 2001/005; B60K 2001/006; F16C 2380/26; H01M 2220/20

(57) ABSTRACT

A coolant circulation system includes: a motor including a rotor, a stator, a rotary shaft, and sliding bearings; a gas-liquid separator that separates a coolant into CO₂ and oil; a CO₂ passage through which the CO₂ separated by the gas-liquid separator is supplied to a gap between the rotor and the stator to cool the rotor and the stator; mixture passages through which a mixture of the CO₂ and the oil obtained by mixing the CO₂ and the oil separated by the gas-liquid separator is supplied to gaps between the rotary shaft and the sliding bearings to lubricate the sliding bearings; and mixture passages through which the CO₂ supplied to the rotor and the stator from the CO₂ passage, and the mixture of the CO₂ and the oil supplied to the sliding bearings from the mixture passages are returned to the gas-liquid separator.

### TECHNICAL FIELD

The present disclosure relates to a coolant circulation system that circulates a coolant containing oil.

### BACKGROUND ART

Conventionally, in a refrigeration cycle that is used in an air conditioner or the like, a coolant circulation system that circulates coolant via a compressor, a heat exchanger, or the like has been used. In recent years, such a coolant circulation system has also been utilized to cool or to raise the temperature of various components (a motor, a battery, and the like, for example) in a vehicle.

In the coolant circulation system of this kind, in general, a coolant containing oil (refrigerant oil) is used to lubricate or seal various components, and this oil also circulates through the system. Japanese Patent Laid-Open No. 2016-000960, for example, describes a system in which a coolant containing oil is used to cool the rotor and the stator of the motor of an electric compressor, and to lubricate and cool the rotary shaft and the bearing of the motor.

### SUMMARY

### Technical Problem

In recent years, for environmental considerations or the like, a technique has been developed that uses a natural coolant in a refrigeration cycle. In a case in which the motor and the like of a vehicle are cooled by such a natural coolant, it is desirable for the natural coolant to have an insulating property and hence, a method can be considered in which a coolant containing CO₂ (specifically, a coolant containing CO₂ with oil or the like, hereinafter referred to as “CO₂ coolant” when appropriate) or the like is used.

In the above-mentioned technique described in Japanese Patent Laid-Open No. 2016-000960, the coolant (CO₂ coolant or the like) is used to cool the rotor and the stator of the motor, and to lubricate the bearing of the motor. However, this technique has the following problems. First, in the technique described in Japanese Patent Laid-Open No. 2016-000960, the coolant is made to contain oil (lubricating oil) and hence, it can be regarded that such a coolant is effective in lubricating the bearing of the motor. However, there is a problem where, in cooling the rotor and the stator of the motor with the coolant, stirring resistance is generated between the rotor and the stator due to the oil in the coolant. To be more specific, when the coolant passes through a gap formed between the rotor and the stator, a large shearing resistance is generated due to the viscosity of the oil in the coolant, thus increasing stirring resistance. Such stirring resistance lowers a torque outputted from the motor.

The present disclosure has been made to solve the above-described problems of the conventional technique, and it is an object of the present disclosure to reduce stirring resistance generated in the motor due to the coolant, in a coolant circulation system in which a coolant containing oil is circulated to cool and lubricate the motor.

### Solution to Problem

To achieve the above-mentioned object, the present disclosure is directed to a coolant circulation system that is mounted in a vehicle to circulate a coolant containing CO₂ with oil, the coolant circulation system comprising: a motor for driving the vehicle, the motor including a rotor and a stator, a rotary shaft coupled to the rotor, and a sliding bearing that supports the rotary shaft; a gas-liquid separator that separates the coolant into the oil and the CO₂ as a gas; a first passage through which the CO₂ separated by the gas-liquid separator is supplied to a gap between the rotor and the stator of the motor to cool the rotor and/or the stator; a second passage through which a mixture of the CO₂ and the oil obtained by mixing the CO2 and the oil separated by the gas-liquid separator is supplied to a gap between the rotary shaft and the sliding bearing of the motor to lubricate the sliding bearing; and a third passage through which the CO₂ supplied to the rotor and the stator from the first passage, and the mixture of the CO₂ and the oil supplied to the sliding bearing from the second passage are returned to the gas-liquid separator.

In such a configuration, the mixture of the CO₂ and the oil is supplied to the sliding bearing of the motor, whereas only the CO₂ is supplied to the rotor and the stator of the motor. That is, according to the present disclosure, a coolant containing oil (i.e., the mixture), that is, a coolant having a certain degree of viscosity, is supplied to the sliding bearing, whereas a coolant containing no oil (essentially, only CO₂), that is, a coolant having low viscosity, can be supplied to the rotor and the stator. Thus, according to the present disclosure, lubricity of the sliding bearing is ensured, and it is possible to reduce stirring resistance generated between the rotor and the stator due to the coolant.

In the present disclosure, it is preferable that the motor further include a housing and a seal, the housing house the rotor, the stator, the rotary shaft, and the sliding bearing, the seal a gap between the rotary shaft and the housing by making use of the oil, and the coolant circulation system further include a fourth passage through which the oil separated by the gas-liquid separator is supplied to the seal of the motor.

According to such a configuration, as described above, it is possible to ensure lubricity of the sliding bearing, and to reduce stirring resistance generated between the rotor and the stator, and it is possible to ensure scalability of the seal.

In the present disclosure, it is preferable that a plurality of groove parts extending along a circumferential direction be formed on an outer peripheral surface of the rotor or on an inner peripheral surface of the stator and are configured to disperse the CO₂ in the gap between the rotor and the stator.

As described above, when the CO₂ is supplied to the rotor and the stator, although stirring resistance can be reduced, the CO₂ has low viscosity and hence, it is difficult for the CO₂ to spread through the entire gap formed between the rotor and the stator. To cope with this problem, in the present disclosure, the plurality of groove parts are provided to the outer peripheral surface of the rotor. Due to such a plurality of groove parts, it is possible to promote the flow of the CO₂ in the gap formed between the rotor and the stator and hence, the CO₂ can be spread through the entire gap formed between the rotor and the stator.

In the present disclosure, it is preferable that each of the plurality of groove parts be formed such that a portion on a trailing side relative to a rotational direction of the rotor has a depth greater than a depth of a portion on a leading side relative to the rotational direction of the rotor.

According to such a configuration, the CO₂ can be drawn into each groove part from the portion of the groove part which is located on the leading side and is formed to have a smaller depth (that is, the end part of the groove part on the leading side), and the CO₂ drawn into the groove part in this manner can be made to vigorously flow out from the portion of the groove part which is located on the trailing side and is formed to have a larger depth (that is, the end part of the groove part on the trailing side). Thus, according to the present disclosure, it is possible to effectively promote the flow of the CO₂ in the gap formed between the rotor and the stator.

In the present disclosure, it is preferable that the first passage be configured to supply the CO₂ to a center part of the rotor and the stator in an axial direction, and that each of the plurality of groove parts be formed to be inclined such that a distance from the center part in the axial direction increases as each of the plurality of groove parts extends in a direction opposite to the rotational direction of the rotor.

Due to the groove parts formed to be inclined in this manner, it is possible to generate the flows of the CO₂ having components in the circumferential direction and the axial direction (particularly, in the axial directions toward the end parts of the rotor). Thus, according to the present disclosure, the CO₂ supplied from the first passage to the center part in the axial direction can be made to appropriately flow toward the end parts of the rotor and the stator in the axial direction and hence, the CO₂ can be effectively spread through the entire gap formed between the rotor and the stator.

In the present disclosure, it is preferable that the coolant circulation system further include a mixer configured to increase a proportion of the oil in the mixture as a rotational speed of the motor decreases, and to increase a proportion of the CO₂ in the mixture as the rotational speed of the motor increases.

According to the present disclosure having such a configuration, the viscosity of the mixture used for the sliding bearing can be changed according to the rotational speed of the motor and hence, a desired load capacity of the sliding bearing can be achieved.

In the present disclosure, it is preferable that the coolant circulation system further include: an air conditioner that performs air-conditioning by using the coolant; a battery that supplies electric power for driving the motor; a fifth passage through which the CO₂ separated by the gas-liquid separator is supplied to the air conditioner; a sixth passage through which the CO₂ separated by the gas-liquid separator is supplied to the battery; and a multi-way valve configured to be capable of switching a passage, through which the CO₂ separated by the gas-liquid separator is supplied, to at least one of the first passage, the second passage, the fifth passage, or the sixth passage, or combinations thereof.

According to such a configuration, the passage for supplying the CO₂ is switched with the multi-way valve and hence, it is possible to appropriately share the coolant circulation system that performs cooling with the coolant between the motor, the air conditioner, and the battery.

### Advantageous Effects

According to the present disclosure, in the coolant circulation system in which a coolant containing oil is circulated to cool and lubricate the motor, it is possible to reduce stirring resistance generated in the motor due to the coolant.

### BRIEF DESCRIPTION OF DRAWINGS

FIG. 1 is a schematic configuration diagram of a vehicle to which a coolant circulation system according to an embodiment of the present disclosure is applied.

FIG. 2 is a schematic configuration diagram of the coolant circulation system according to the embodiment of the present disclosure.

FIG. 3 is a schematic configuration diagram of a motor according to the embodiment of the present disclosure.

FIG. 4 is a schematic perspective view of a rotor of the motor according to the embodiment of the present disclosure.

FIG. 5 is a schematic cross-sectional view of the rotor according to the embodiment of the present disclosure, taken along line V-V in FIG. 4.

FIG. 6 is an enlarged perspective view of groove parts of the rotor according to the embodiment of the present disclosure.

FIG. 7 is an explanatory diagram of the flow of CO₂ through the groove parts of the rotor according to the embodiment of the present disclosure.

### DETAILED DESCRIPTION

Hereinafter, a coolant circulation system according to an embodiment of the present disclosure will be described with reference to attached drawings.

### Overall Configuration

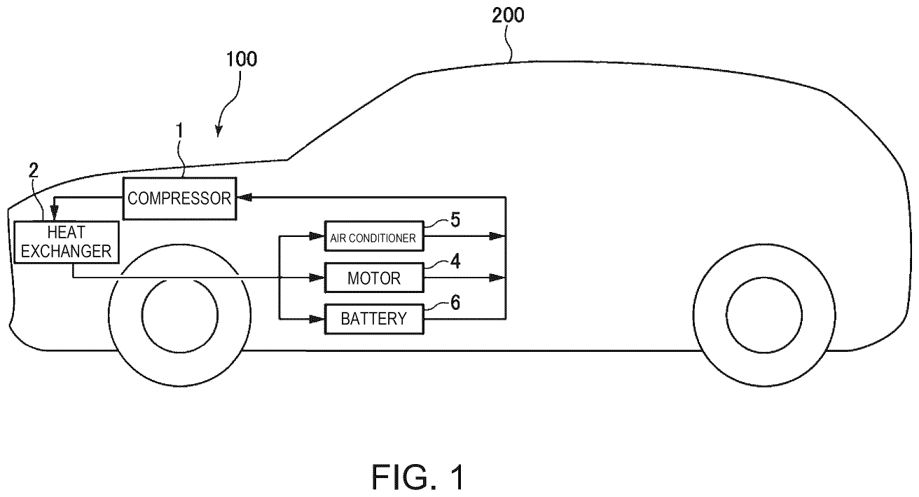

First, the overall configuration of the coolant circulation system according to the present embodiment will be described with reference to FIG. 1. FIG. 1 is a schematic configuration diagram of a vehicle to which the coolant circulation system according to the present embodiment is applied.

As shown in FIG. 1, a vehicle 200 is, for example, an electric vehicle, and includes a coolant circulation system 100 that circulates coolant in a refrigeration cycle. This coolant circulation system 100 mainly includes a compressor 1 for compressing coolant, a heat exchanger 2 for cooling the coolant compressed by the compressor 1, a motor 4 (electric motor) that generates power for driving the vehicle 200, an air conditioner 5 that performs air-conditioning in the vehicle 200, and a battery 6 that supplies electric power for driving the motor 4.

The coolant circulation system 100 circulates CO₂ coolant (hereinafter, CO₂ coolant may be simply referred to as “coolant”) as natural coolant. This CO₂ coolant is a coolant containing CO₂ with refrigerant oil (oil), such as polyalkylene glycol (PAG), or an additive, for example. Such a CO₂ coolant is used and hence, the compressor 1 is configured to compress the coolant to an extremely high pressure. The motor 4 uses the coolant compressed by the compressor 1 in this manner (typically, coolant in a supercritical state) to lubricate a sliding bearing that supports a rotary shaft, or to cool a rotor and a stator. In this case, the motor 4 is configured to serve as an evaporator in the refrigeration cycle. The coolant compressed by the compressor 1 is also used for air-conditioning performed by the air conditioner 5, and for cooling the battery 6. For example, in the coolant circulation system 100, high temperature and high pressure gas coolant is supplied from the compressor 1 to the heat exchanger 2, low temperature high pressure liquid coolant is supplied from the heat exchanger 2 to the motor 4 and the like, and normal temperature and low pressure gas coolant is supplied from the motor 4 and the like to the compressor 1.

### Configuration of Coolant Circulation System

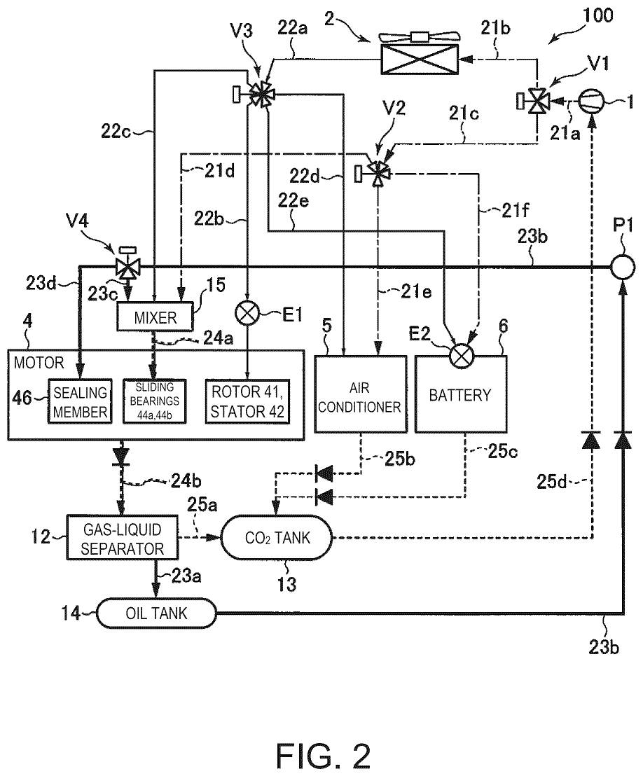

Next, the coolant circulation system 100 according to the present embodiment will be specifically described with reference to FIG. 2. FIG. 2 is a schematic configuration diagram of the coolant circulation system 100 according to the present embodiment.

As shown in FIG. 2, in addition to the above-mentioned compressor 1, heat exchanger 2, motor 4, air conditioner 5, and battery 6, the coolant circulation system 100 mainly includes a gas-liquid separator 12 for separating coolant into CO₂ and oil, a CO₂ tank 13 and an oil tank 14 for respectively storing the CO₂ and the oil separated by the gas-liquid separator 12, a mixer 15 for mixing CO₂ and oil, CO₂ passages 21a to 21f, 22a to 22e, 25a to 25d through which the CO₂ (which is hereinafter assumed to contain a small amount of oil) separated by the gas-liquid separator 12 passes, oil passages 23a to 23d through which the oil separated by the gas-liquid separator 12 passes, mixture passages 24a, 24b through which a mixture of CO₂ and oil passes, multi-way valves V1 to V4, each of which can switch a passage that supplies CO₂ or oil, an expansion valve E1 with which CO₂ to be supplied to the motor 4 is expanded, and an expansion valve E2 with which CO₂ to be supplied to the battery 6 is expanded. Note that the CO₂ passages 21a to 21f (shown by chain lines in FIG. 2) are passages through which CO₂ is made to flow for temperature raising (heating), and the CO₂ passages 22a to 22e (shown by thin solid lines in FIG. 2) are passages through which CO₂ is made to flow to perform cooling.

CO₂ is supplied to the compressor 1 through the CO₂ passage 25d, more specifically, CO₂ stored in the CO₂ tank 13 is supplied to the compressor 1. The compressor 1 compresses this CO₂, and supplies the CO₂ to the multi-way valve V1 through the CO₂ passage 21a. The multi-way valve V1 (i.e., three-way valve) is configured to be able to select at least one or more from a supply of the CO₂ to the heat exchanger 2 through the CO₂ passage 21b and a supply of the CO₂ to the multi-way valve V2 through the CO₂ passage 21c. The multi-way valve V2 (i.e., four-way valve) is configured to be able to select at least one or more from a supply of the CO₂ to the mixer 15 through the CO₂ passage 21d, a supply of the CO₂ to the air conditioner 5 through the CO₂ passage 21e, and a supply of the CO₂ to the battery 6 through the CO₂ passage 21f. In this case, the air conditioner 5 serves as a heater due to the supplied CO₂, and the temperature of the battery 6 is raised by the supplied CO₂.

Subsequently, the CO₂ is supplied to the heat exchanger 2 from the multi-way valve V1 through the CO₂ passage 21b. The heat exchanger 2 exchanges heat between this CO₂ and outside air to cool the CO₂, and supplies the CO₂ to the multi-way valve V3 through the CO₂ passage 22a. The multi-way valve (i.e., five-way valve) V3 is configured to be able to select at least one or more from a supply of the CO₂ to a rotor 41 and a stator 42 of the motor 4 through the CO₂ passage 22b, a supply of the CO₂ to the mixer 15 through the CO₂ passage 22c, a supply of the CO₂ to the air conditioner 5 through the CO₂ passage 22d, and a supply of the CO₂ to the battery 6 through the CO₂ passage 22c. In this case, the rotor 41 and the stator 42 of the motor 4 are cooled by the supplied CO₂, the air conditioner 5 serves as a cooler due to the supplied CO₂, and the battery 6 is cooled by the supplied CO₂. Note that the CO₂ is supplied to the rotor 41 and the stator 42 of the motor 4 via the expansion valve E1, that is, CO₂ that is reduced in pressure by the expansion valve E1 is supplied to the rotor 41 and the stator 42 of the motor 4. The CO₂ is supplied to the battery 6 via the expansion valve E2, that is, CO₂ that is reduced in pressure by the expansion valve E2 is supplied to the battery 6.

On the other hand, oil stored in the oil tank 14 is supplied to the multi-way valve V4 through the oil passage 23b. In this case, the oil is pressure-fed by an oil pump P1 in the oil passage 23b. The multi-way valve (i.e., three-way valve) V4 is configured to be able to select at least one or more from a supply of the oil to the mixer 15 through the oil passage 23c and a supply of the oil to a seal 46 of the motor 4 through the oil passage 23d. The mixer 15 mixes the CO₂ supplied from the CO₂ passages 21d, 22c and the oil supplied from the oil passage 23c, and supplies a mixture of the CO₂ and the oil to sliding bearings 44a, 44b of the motor 4 through the mixture passages 24a. Note that the mixer 15 is configured to be able to change the mixing ratio between CO₂ and oil by a control device not shown in the drawing.

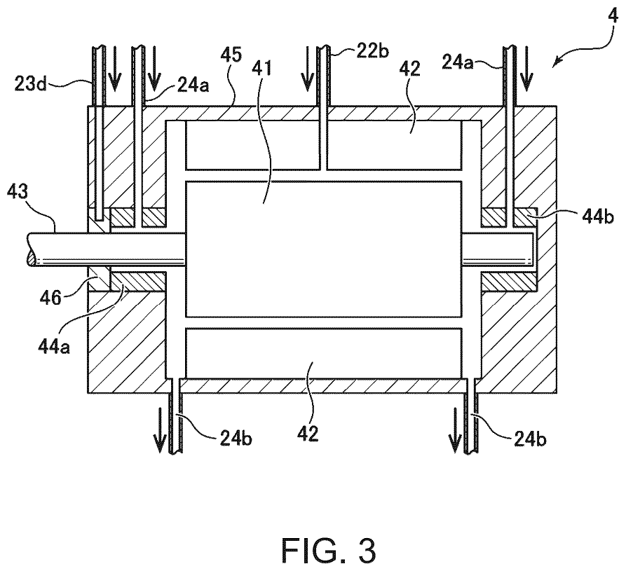

The configuration of the motor 4 according to the present embodiment will be specifically described with reference to FIG. 3. FIG. 3 is a schematic configuration diagram of the motor 4 according to the present embodiment. To be more specific, FIG. 3 is a cross-sectional view of the motor 4 taken along the axial direction.

As shown in FIG. 3, the motor 4 mainly includes the rotor 41 and the stator 42, a rotary shaft 43 that is coupled to this rotor 41, and that has one end thereof connected to the transaxle (not shown in the drawing) or the like of the vehicle 200, a pair of sliding bearings 44a, 44b that supports this rotary shaft 43, and a housing 45 that houses the rotor 41, the stator 42, the rotary shaft 43, the sliding bearings 44a, 44b, and the like.

As described above, in the motor 4, the CO₂ is supplied from the CO₂ passage 22b to the rotor 41 and the stator 42. More specifically, the CO₂ from the CO₂ passage 22b is supplied to the center part of the rotor 41 and the stator 42 in the axial direction, and this CO₂ spreads through the entire gap formed between the rotor 41 and the stator 42. The CO₂ supplied in this manner is used to cool the rotor 41 and the stator 42, particularly, to cool a coil (not shown in the drawing) in the stator 42. In this case, the CO₂ exchanges heat with the stator 42 and the like having a relatively high temperature (at this point of operation, the coolant evaporates at the coil of the stator 42) and hence, the function of an evaporator in the refrigeration cycle is achieved.

In the motor 4, the mixture of the CO₂ and the oil is supplied from the mixture passage 24a to each of the pair of sliding bearings 44a, 44b, more specifically, the mixture is supplied to gaps formed between the rotary shaft 43 and the sliding bearings 44a, 44b. The sliding bearings 44a, 44b are configured to perform lubrication by using the mixture, as a lubricant, supplied in this manner. In this case, the sliding bearings 44a, 44b perform lubrication by using the mixture in a liquid state (typically, a coolant containing CO₂ in a supercritical state).

The motor 4 further includes the seal 46 for providing a scaling to a portion of the rotary shaft 43 on a side on which the rotary shaft 43 is connected to the transaxle or the like (a side on which the sliding bearing 44a is provided). This seal 46 is provided to prevent leakage of coolant from a gap formed between the housing 45 and a portion of the rotary shaft 43 that extends outward from the housing 45. As described above, the oil is supplied to the seal 46 from the oil passage 23d, and the seal 46 is configured as a mechanical seal that prevents leakage of the coolant by making use of this oil.

The CO₂ used by the rotor 41 and the stator 42 for cooling, the mixture used by the sliding bearings 44a, 44b for lubrication, and the oil used by the seal 46 for sealing flow out together from the mixture passages 24b, and are returned to the gas-liquid separator 12 (FIG. 1).

Note that in an electric vehicle, the rotary shaft 43 of the motor 4 is rotated at a high rotational speed of more than 30,000 rpm, for example, and hence, when rolling bearings are used in the motor 4, there may be a problem with the lifespan due to rolling fatigue. In contrast, when general sliding bearings that use oil are used in the motor 4, there is a large loss in oil stirring resistance due to the rotary shaft 43. Accordingly, in the present embodiment, the motor 4 utilizes the sliding bearings 44a, 44b that use coolant which is brought into a liquid state (e.g., supercritical state) by compression in the compressor 1. Consequently, problems such as rolling fatigue and oil stirring resistance can be solved.

In addition, in the present embodiment, in using the mixture of the CO₂ and the oil for the sliding bearings 44a, 44b in this manner, a mixing ratio between the CO₂ and the oil is changed according to the motor speed (corresponding to a rotational speed of the rotary shaft 43 of the motor 4). This adjustment of the mixing ratio is achieved by controlling the mixer 15 by the control device. To be more specific, in the present embodiment, a lower motor speed causes a lower load capacity of the sliding bearings 44a, 44b and hence, to ensure a desired load capacity (that is, to increase the viscosity of the mixture), the proportion of the oil in the mixture is increased. In contrast, a higher motor speed can ensure a higher load capacity of the sliding bearings 44a, 44b due to a wedge effect or a throttling effect, thus does not require a high ratio of oil in the mixture (that is, it is not necessary to increase the viscosity of the mixture). Accordingly, the proportion of oil in the mixture is reduced, that is, the proportion of CO₂ in the mixture is increased.

Returning to FIG. 2, the mixture of the CO₂ and the oil is supplied to the gas-liquid separator 12 from the motor 4 through the mixture passages 24b, and the gas-liquid separator 12 performs gas-liquid separation (e.g., gas-oil separation), separating this mixture into CO₂ and oil. Then, the gas-liquid separator 12 supplies the separated oil to the oil tank 14 through the oil passage 23a. Further, the gas-liquid separator 12 supplies the separated CO₂ to the CO₂ tank 13 through the CO₂ passage 25a. CO₂ is supplied to this CO₂ tank 13 also from the air conditioner 5 through the CO₂ passage 25b and from the battery 6 through the CO₂ passage 25c.

Note that the CO₂ passage 22b is an example of a “first passage” in the present disclosure, the mixture passages 24a are examples of a “second passage” in the present disclosure, the mixture passages 24b are examples of a “third passage” in the present disclosure, the oil passage 23d is an example of a “fourth passage” in the present disclosure, the CO₂ passages 21e, 22d are examples of a “fifth passage” in the present disclosure, and the CO₂ passages 21f, 22e are examples of a “sixth passage” in the present disclosure.

### Configuration of Rotor

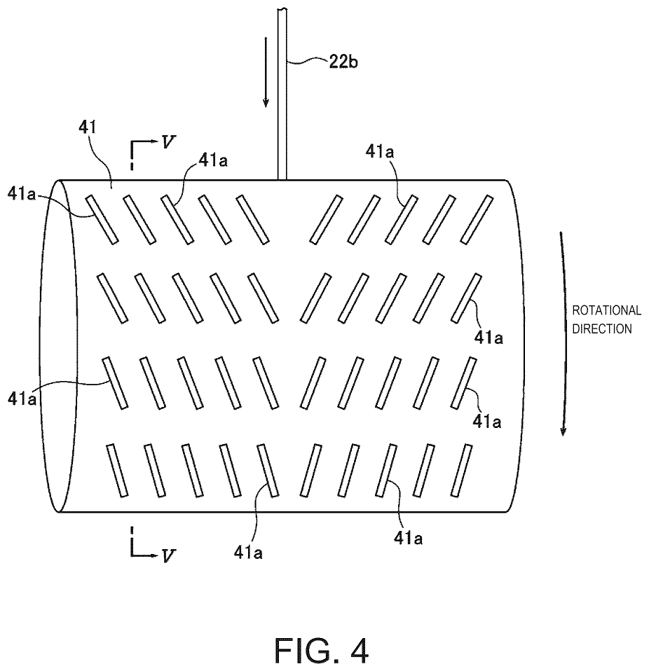

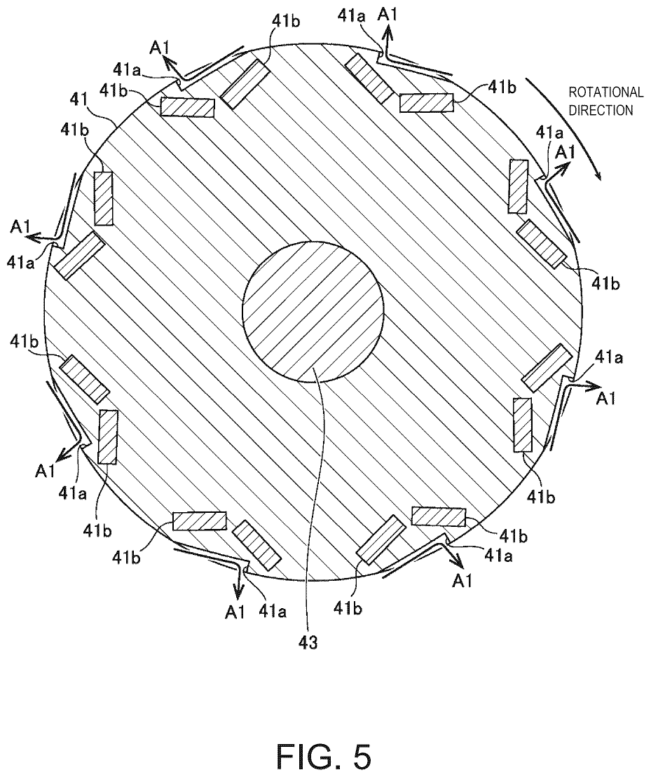

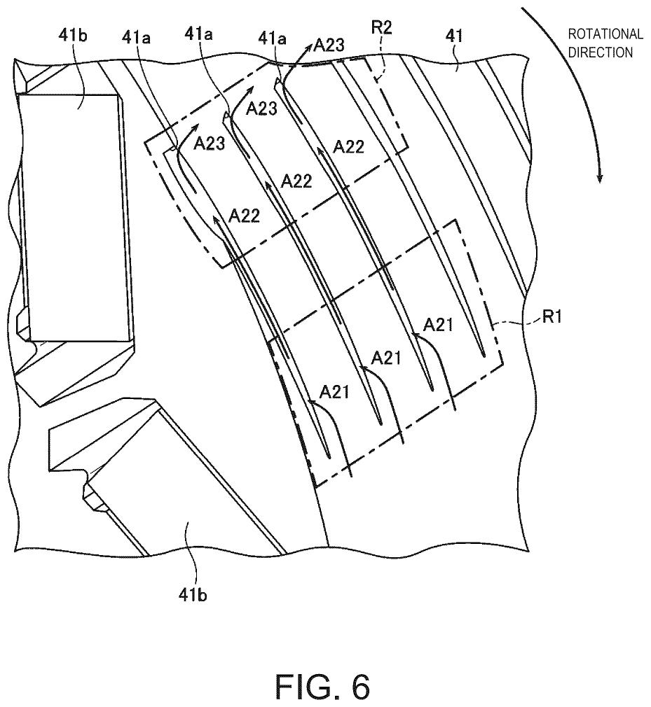

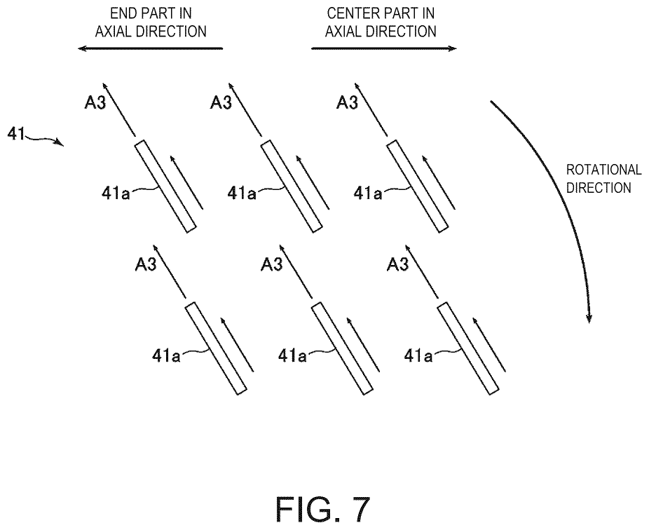

Next, the configuration of the rotor 41 of the motor 4 according to the present embodiment will be described with reference to FIGS. 4 to 7. FIG. 4 shows a schematic perspective view of the rotor 41, FIG. 5 shows a schematic cross-sectional view of the rotor 41 taken along line V-V in FIG. 4, FIG. 6 shows an enlarged perspective view of groove parts 41a of the rotor 41, and FIG. 7 is an explanatory diagram of the flow of CO₂ through the groove parts 41a of the rotor 41. Note that FIG. 7 shows a schematic plan view of some of the plurality of groove parts 41a.

As shown in FIG. 4, in the present embodiment, the plurality of groove parts 41a extending along the circumferential direction of the rotor 41 are formed on the outer peripheral surface of the rotor 41 of the motor 4. Before describing the specific configuration of the groove part 41a, first, a reason will be given for providing the groove parts 41a to the rotor 41 in the present embodiment. The CO₂ supplied from the CO₂ passage 22b to the gap formed between the rotor 41 and the stator 42 contains almost no oil (due to oil being separated by the gas-liquid separator 12) and thus has low viscosity, and hence, stirring resistance between the rotor 41 and the stator 42 can be reduced. However, due to the low viscosity, it is difficult for the CO₂ to spread through the entire gap formed between the rotor 41 and the stator 42. Particularly, when a small amount of CO₂ is supplied, it is difficult for the CO₂ to spread. Accordingly, in the present embodiment, to disperse CO₂ over the entire gap formed between the rotor 41 and the stator 42, the plurality of groove parts 41a are provided to the outer peripheral surface of the rotor 41.

Subsequently, the specific configuration of the groove parts 41a according to the present embodiment will be described. As shown in FIG. 4, the plurality of groove parts 41a are symmetrically (e.g., bilaterally symmetrically) arranged with respect to the center part of the rotor 41 in the axial direction (a portion to which CO₂ is supplied from the CO₂ passage 22b). The plurality of groove parts 41a are located on the respective left and right sides across this center part, and are arranged at equal intervals in the axial direction and the circumferential direction. Further, each of the plurality of groove parts 41a is formed to be inclined such that the distance from the center part in the axial direction increases as the groove part 41a extends in the direction opposite to a rotational direction of the rotor 41. When viewed as a whole, the plurality of groove parts 41a provided to the rotor 41 in this manner form a V shape that is symmetrical with respect to the center part of the rotor 41.

As shown in FIG. 5 and FIG. 6, each of the plurality of groove parts 41a is formed such that a portion on a trailing side, that is, a side opposite to a side in the rotational direction of the rotor 41 (a portion in a region R2 in FIG. 6), has a depth greater than the depth of a portion on a leading side, that is, the side in the rotational direction of the rotor 41 (a portion in a region R1 in FIG. 6). For example, each groove part 41a is formed such that the maximum depth (the depth of the portion in the region R2) is substantially the same as the clearance between the rotor 41 and the stator 42. Further, the plurality of groove parts 41a are provided at positions corresponding to a plurality of pairs of electromagnetic steel sheets 41b, which are provided in the rotor 41 (inside the rotor 41 at positions in the vicinity of the outer peripheral surface of the rotor 41) at equal intervals along the circumferential direction (FIG. 5). Particularly, the groove parts 41a are provided at positions that do not adversely affect the strength of the electromagnetic steel sheets 41b and formation of an electromagnetic field, that is, the electromagnetic performance.

Next, the flow of the CO₂ caused by the plurality of groove parts 41a will be specifically described. Due to the groove parts 41a according to the present embodiment, first, the CO₂ is drawn into each groove part 41a (arrows A21 in FIG. 6) from the portion of the groove part 41a which is located on the leading side and is formed to have a smaller depth (that is, the end part of the groove part 41a on the leading side), and this CO₂ flows through the groove part 41a (arrows A22 in FIG. 6). Then, the CO₂ in the groove part 41a vigorously flows out to the outside from the portion of the groove part 41a which is located on the trailing side and is formed to have a larger depth (that is, the end part of the groove part 41a on the trailing side) (arrows A23 in FIG. 6). In this case, the flow of the CO₂ toward the radial-direction outer side of the rotor 41 is generated (arrows A1 in FIG. 5).

As described above, due to the groove parts 41a according to the present embodiment, it is possible to generate a flow of the CO₂ which has components in the circumferential direction and the axial direction (particularly, in the axial direction toward the end part of the rotor 41), as shown by arrows A3 in FIG. 7. Consequently, the CO₂ can be spread through the entire gap formed between the rotor 41 and the stator 42. In this case, the CO₂ supplied to the center part in the axial direction from the CO₂ passage 22b can be appropriately spread toward the end parts of the rotor 41 in the axial direction.

Note that according to examinations performed by the inventors of the present disclosure, it is found that when using groove parts that have a uniform depth in the circumferential direction and have a substantially rectangular shape in cross section, local eddies are formed in the groove parts, so that CO₂ cannot be made to spread as in the case of the above-mentioned present embodiment. It is also found that when using groove parts, each of which has a bottom surface with an arc shape in cross section, such as a bottom surface having the same depth on the leading side and the trailing side in the circumferential direction, CO₂ flows through areas between the groove parts and hence, the CO₂ cannot be made to spread as in the case of the above-mentioned present embodiment.

### Manner of Operation and Advantageous Effects

Next, the manner of operation and advantageous effects of the coolant circulation system 100 according to the present embodiment will be described. The coolant circulation system 100 according to the present embodiment includes: the motor 4 including the rotor 41 and the stator 42, the rotary shaft 43 coupled to the rotor 41, and the sliding bearings 44a, 44b that support the rotary shaft 43, the motor 4 driving the vehicle 200; the gas-liquid separator 12 that separates the coolant into oil and CO₂ as a gas; the CO₂ passage 22b through which the CO₂ separated by the gas-liquid separator 12 is supplied to a gap between the rotor 41 and the stator 42 of the motor 4 to cool the rotor 41 and the stator 42; the mixture passages 24a through which a mixture of the CO₂ and the oil obtained by mixing the CO₂ and the oil separated by the gas-liquid separator 12 is supplied to gaps between the rotary shaft 43 and the sliding bearings 44a, 44b of the motor 4 to lubricate the sliding bearings 44a, 44b; and the mixture passages 24b through which the CO₂ supplied to the rotor 41 and the stator 42 from the CO₂ passage 22b, and the mixture of the CO₂ and the oil supplied to the sliding bearings 44a, 44b from the mixture passages 24a are returned to the gas-liquid separator 12.

In the present embodiment having such a configuration, the mixture of the CO₂ and the oil is supplied to the sliding bearings 44a, 44b of the motor 4, whereas only the CO₂ is supplied to the rotor 41 and the stator 42 of the motor 4. That is, according to the present embodiment, a coolant containing oil, that is, a coolant having a certain degree of viscosity, is supplied to the sliding bearings 44a, 44b, whereas a coolant containing no oil (basically, only CO₂), that is, a coolant having low viscosity, can be supplied to the rotor 41 and the stator 42. Thus, according to the present embodiment, lubricity of the sliding bearings 44a, 44b is ensured, and it is possible to reduce stirring resistance generated between the rotor 41 and the stator 42.

According to the present embodiment, the motor 4 further includes the housing 45 and the seal 46, the housing 45 housing the rotor 41, the stator 42, the rotary shaft 43, and the sliding bearings 44a, 44b, the seal 46 sealing the gap between the rotary shaft 43 and the housing 45 by making use of oil, and the coolant circulation system 100 further includes the oil passage 23d through which the oil separated by the gas-liquid separator 12 is supplied to the seal 46 of the motor 4. Consequently, it is possible to ensure lubricity of the sliding bearings 44a, 44b, and to reduce stirring resistance generated between the rotor 41 and the stator 42, and it is possible to ensure scalability of the seal 46.

According to the present embodiment, the plurality of groove parts 41a extending along the circumferential direction are formed on the outer peripheral surface of the rotor 41 to disperse the CO₂ in the gap formed between the rotor 41 and the stator 42. As described above, when the CO₂ is supplied to the rotor 41 and the stator 42, although stirring resistance can be reduced, the CO₂ has low viscosity and hence, it is difficult for the CO₂ to spread through the entire gap formed between the rotor 41 and the stator 42. To cope with this problem, in the present embodiment, the plurality of groove parts 41a are provided to the outer peripheral surface of the rotor 41. Due to such a plurality of groove parts 41a, it is possible to promote the flow of the CO₂ in the gap formed between the rotor 41 and the stator 42 and hence, the CO₂ can be spread through the entire gap formed between the rotor 41 and the stator 42.

According to the present embodiment, each of the plurality of groove parts 41a is formed such that a portion on a trailing side of the rotor 41 has a depth greater than a depth of a portion on the leading side of the rotor 41. Consequently, the CO₂ can be drawn into each groove part 41a from the portion of the groove part 41a which is located on the leading side and is formed to have a smaller depth (that is, the end part of the groove part 41a on the leading side) and, then, the CO₂ drawn into the groove part 41a in this manner can be made to vigorously flow out from the portion of the groove part 41a which is located on the trailing side, and is formed to have a larger depth (that is, the end part of the groove part 41a on the trailing side). Thus, according to the present embodiment, it is possible to effectively promote the flow of the CO₂ in the gap formed between the rotor 41 and the stator 42.

According to the present embodiment, the CO₂ passage 22b is configured to supply the CO₂ to the center part of the rotor 41 and the stator 42 in the axial direction, and each of the plurality of groove parts 41a is formed to be inclined such that a distance from the center part in the axial direction increases as each of the plurality of groove parts 41a extends in the direction opposite to the rotational direction of the rotor 41. Due to the groove parts 41a inclined in this manner, it is possible to generate the flows of the CO₂ having components in the circumferential direction and the axial direction (particularly, in the axial directions toward the end parts of the rotor 41). Thus, according to the present embodiment, the CO₂ supplied to the center part in the axial direction from the CO₂ passage 22b can be made to appropriately flow toward the end parts of the rotor 41 and the stator 42 in the axial direction and hence, the CO₂ can be effectively spread through the entire gap formed between the rotor 41 and the stator 42.

According to the present embodiment, the coolant circulation system 100 further includes the mixer 15 configured to increase the proportion of the oil in the mixture as the motor speed decreases, and to increase the proportion of the CO₂ in the mixture as the motor speed increases. Consequently, the viscosity of the mixture used for the sliding bearings 44a, 44b can be changed according to the motor speed and hence, a desired load capacity of the sliding bearings 44a, 44b can be achieved (typically, it is possible to achieve a constant load capacity irrespective of the motor speed).

According to the present embodiment, the coolant circulation system 100 further includes: the air conditioner 5 that performs air-conditioning by using the coolant; the battery 6 that supplies electric power for driving the motor 4; the CO₂ passage 22d through which the CO₂ separated by the gas-liquid separator 12 is supplied to the air conditioner 5; the CO₂ passage 22e through which the CO₂ separated by the gas-liquid separator 12 is supplied to the battery 6; and the multi-way valve V3 configured to be capable of switching the passage, through which the CO₂ separated by the gas-liquid separator 12 is supplied, to at least one of the CO₂ passage 22b, the CO₂ passage 22c, the CO₂ passage 22d, or the CO₂ passage 22e, or combinations thereof. According to the present embodiment having such a configuration, the passage for supplying the CO₂ is switched with the multi-way valve V3 and hence, it is possible to appropriately share the coolant circulation system 100 that performs cooling with the coolant between the motor 4, the air conditioner 5, and the battery 6.

### Modification

In the above-mentioned embodiment, the plurality of groove parts 41a are provided to the outer peripheral surface of the rotor 41. However, in a modification, the plurality of groove parts 41a may be provided to the inner peripheral surface of the stator 42. Also due to the plurality of groove parts 41a provided to the stator 42 in this manner, it is possible to promote the flow of the CO₂ in the gap formed between the rotor 41 and the stator 42 and hence, the CO₂ can be spread through the entire gap formed between the rotor 41 and the stator 42.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

Further, if used herein, a phrase of the form “at least one of A and B” means at least one A or at least one B, without being mutually exclusive of each other, and does not require at least one A and at least one B. If used herein, the phrase “and/or” means either or both of two stated possibilities. Moreover, the meaning of “at least one of a, b, c, or d” is to define an open set, with one or more of the elements in combination (a, b, c and/or d, not excluding other elements like e).

### REFERENCE CHARACTER LIST

1 compressor
2 heat exchanger
4 motor
5 air conditioner
6 battery
12 gas-liquid separator
15 mixer
21a to 21f, 22a to 22e, 25a to 25d CO₂ passage
23a to 23d oil passage
24a, 24b mixture passage
41 rotor
41a groove part
41b steel sheet
42 stator
43 rotary shaft
44a, 44b sliding bearing
45 housing
46 seal
100 coolant circulation system
200 vehicle
E1, E2 expansion valve
V1, V2, V3, V4 multi-way valve

1. A coolant circulation system that is mounted in a vehicle to circulate a coolant containing CO₂ with oil, the coolant circulation system comprising:
a motor for driving the vehicle, the motor including a rotor and a stator, a rotary shaft coupled to the rotor, and a sliding bearing that supports the rotary shaft;
a gas-liquid separator that separates the coolant into the oil and the CO₂ as a gas;
a first passage through which the CO₂ separated by the gas-liquid separator is supplied to a gap between the rotor and the stator of the motor to cool the rotor and/or the stator;
a second passage through which a mixture of the CO₂ and the oil obtained by mixing the CO₂ and the oil separated by the gas-liquid separator is supplied to a gap between the rotary shaft and the sliding bearing of the motor to lubricate the sliding bearing; and
a third passage through which the CO₂ supplied to the rotor and the stator from the first passage, and the mixture of the CO₂ and the oil supplied to the sliding bearing from the second passage, are returned to the gas-liquid separator.

2. The coolant circulation system according to claim 1, wherein
the motor further includes a housing and a seal,
the housing houses the rotor, the stator, the rotary shaft, and the sliding bearing,
the seal seals a gap between the rotary shaft and the housing by making use of the oil, and
the coolant circulation system further comprises a fourth passage through which the oil separated by the gas-liquid separator is supplied to the seal of the motor.

3. The coolant circulation system according to claim 1, wherein a plurality of groove parts extending along a circumferential direction are formed on an outer peripheral surface of the rotor or on an inner peripheral surface of the stator and are configured to disperse the CO₂ in the gap between the rotor and the stator.

4. The coolant circulation system according to claim 3, wherein each of the plurality of groove parts is formed such that a portion on a trailing side relative to a rotational direction of the rotor has a depth greater than a depth of a portion on a leading side relative to the rotational direction of the rotor.

5. The coolant circulation system according to claim 3, wherein
the first passage is configured to supply the CO₂ to a center part of the rotor and the stator in an axial direction, and
each of the plurality of groove parts is formed to be inclined such that a distance from the center part in the axial direction increases as each of the plurality of groove parts extends in a direction opposite to a rotational direction of the rotor.

6. The coolant circulation system according to claim 4, wherein
the first passage is configured to supply the CO₂ to a center part of the rotor and the stator in an axial direction, and
each of the plurality of groove parts is formed to be inclined such that a distance from the center part in the axial direction increases as each of the plurality of groove parts extends in a direction opposite to the rotational direction of the rotor.

7. The coolant circulation system according to claim 1, further comprising a mixer configured to increase a proportion of the oil in the mixture as a rotational speed of the motor decreases, and to increase a proportion of the CO₂ in the mixture as the rotational speed of the motor increases.

8. The coolant circulation system according to claim 2, further comprising a mixer configured to increase a proportion of the oil in the mixture as a rotational speed of the motor decreases, and to increase a proportion of the CO₂ in the mixture as the rotational speed of the motor increases.

9. The coolant circulation system according to claim 3, further comprising a mixer configured to increase a proportion of the oil in the mixture as a rotational speed of the motor decreases, and to increase a proportion of the CO₂ in the mixture as the rotational speed of the motor increases.

10. The coolant circulation system according to claim 4, further comprising a mixer configured to increase a proportion of the oil in the mixture as a rotational speed of the motor decreases, and to increase a proportion of the CO₂ in the mixture as the rotational speed of the motor increases.

11. The coolant circulation system according to claim 1, further comprising:
an air conditioner that performs air-conditioning by using the coolant;
a battery that supplies electric power for driving the motor;
a fifth passage through which the CO₂ separated by the gas-liquid separator is supplied to the air conditioner;
a sixth passage through which the CO₂ separated by the gas-liquid separator is supplied to the battery; and
a multi-way valve configured to be capable of switching a passage, through which the CO₂ separated by the gas-liquid separator is supplied, to at least one of the first passage, the second passage, the fifth passage, or the sixth passage, or combinations thereof.

12. The coolant circulation system according to claim 2, further comprising:
an air conditioner that performs air-conditioning by using the coolant;
a battery that supplies electric power for driving the motor;
a fifth passage through which the CO₂ separated by the gas-liquid separator is supplied to the air conditioner;
a sixth passage through which the CO₂ separated by the gas-liquid separator is supplied to the battery; and
a multi-way valve configured to be capable of switching a passage, through which the CO₂ separated by the gas-liquid separator is supplied, to at least one of the first passage, the second passage, the fifth passage, or the sixth passage, or combinations thereof.

13. The coolant circulation system according to claim 3, further comprising:
an air conditioner that performs air-conditioning by using the coolant;
a battery that supplies electric power for driving the motor;
a fifth passage through which the CO₂ separated by the gas-liquid separator is supplied to the air conditioner;
a sixth passage through which the CO₂ separated by the gas-liquid separator is supplied to the battery; and
a multi-way valve configured to be capable of switching a passage, through which the CO₂ separated by the gas-liquid separator is supplied, to at least one of the first passage, the second passage, the fifth passage, or the sixth passage, or combinations thereof.

14. The coolant circulation system according to claim 4, further comprising:
an air conditioner that performs air-conditioning by using the coolant;
a battery that supplies electric power for driving the motor;
a fifth passage through which the CO₂ separated by the gas-liquid separator is supplied to the air conditioner;
a sixth passage through which the CO₂ separated by the gas-liquid separator is supplied to the battery; and
a multi-way valve configured to be capable of switching a passage, through which the CO₂ separated by the gas-liquid separator is supplied, to at least one of the first passage, the second passage, the fifth passage, or the sixth passage, or combinations thereof.
